(19) United States
(12) Patent Application Publication
(10) Pub. No.: US 2005/0160649 A1
(43) Pub. Date: Jul. 28, 2005

(54) Advertising arrangement, display, and advertising method

(75) Inventor: David Bieber, East Greenwich, RI (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Delsey Luggage Inc.

(21) Appl. No.: 10/763,189

(22) Filed: Jan. 26, 2004

(51) Int. Cl. G09F 3/18

(52) U.S. Cl. 40/649; 40/661

(57) ABSTRACT

An advertisement arrangement for an article of merchandise may include a display sleeve having at least one open end. The display sleeve may have a front side with a border and a window with a perimeter defined at least partially by the border. It may also include a back side opposite to the front side. The front and back sides may be flexible so as to permit at least a portion of the article of merchandise to be passed into an interior of the display sleeve via the at least one open end of the display sleeve. An advertising information sheet may be removably disposed within the display sleeve, visible through the window. The advertisement arrangement may be configured to allow the advertising information sheet to be exchanged for a different advertising information sheet.

### FIELD OF THE INVENTION

This invention is directed to an advertising arrangement and advertising method for an article of merchandise.

### BACKGROUND OF THE INVENTION

In a market place, ads and displays attract purchasers and convey information about merchandise for sale. These ads and displays may describe features, and may even include pictures of the merchandise in use. When information about the merchandise changes, the merchandise is sold-out, or the merchandise product-line is cancelled, the ads and displays become outdated, and are discarded, as they have no use.

In some industries, product lines and merchandise change on a regular basis. For example, a product line may be only manufactured and sold for a period of one year, and then replaced with a new product line. When this occurs, any preprinted ads and displays become useless after that year. Furthermore, ads and displays printed for a specific event, such as a sale event or other promotional event, become outdated and are discarded after the event ends.

Some industries use preprinted cardboard or poster board for ads and displays. Printing of these displays can be expensive. In some industries, a large number of displays are ordered to ensure that each distributor receives an amount sufficient to meet its needs. Then, at the end of the event, or when the product line is later cancelled, there are often a large number of unused displays left over. These are then discarded, as they have no use.

Some industries provide a display holder along a shelf edge or on a table adjacent to merchandise for sale. Since the information in these display holders is not attached to the merchandise, potential consumers must associate the information in the display holder with the merchandise to ensure it is accurate.

When merchandise is not conducive to being displayed on a shelf or table because of its size, or for any other reason, a tag may dangle from the merchandise. The tag may include information in a plastic pocket. Such pockets are not effective as advertising displays because they do not have a clean, finished appearance that may persuade some customers to appreciate the product. Further, such dangling pockets often turn or spin, and often must be grasped and held by a consumer for viewing.

Accordingly, it would be desirable to at least partially overcome one or more of the disadvantages of the related art.

### SUMMARY OF THE INVENTION

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

As embodied and broadly described herein, an aspect of the invention includes an advertisement arrangement for an article of merchandise. It may include a display sleeve having at least one open end. The display sleeve may include a front side comprising a border and a window having a perimeter defined at least partially by the border. It may also include a back side opposite to the front side. An advertising information sheet may be removably disposed within the display sleeve and may contain information visible through the window.

The information in the advertising information sheet may pertain to the article of merchandise, and may include information likely to induce a customer to purchase the article of merchandise. As used herein, the phrase “information likely to induce a customer to purchase the article of merchandise” refers to sale information about the merchandise (e.g., a sale price), a sale announcement (e.g., the word “sale”), information about one or more features of the article of merchandise, promotional information, warranty information, service or repair information, or any other information likely to encourage a customer to purchase the merchandise article.

In one aspect, the front and back sides may be flexible so as to permit at least a portion of the article of merchandise to be passed into an interior of the display sleeve via the at least one open end of the display sleeve. The advertisement arrangement may be configured to allow the advertising information sheet to be exchanged for a different advertising information sheet.

In another aspect, the advertising information sheet may be larger than the window. It may be arranged within the display sleeve so that edges of the information sheet are not visible through the window. Further, the advertising information sheet may be removably disposed within the display sleeve.

In another aspect, a transparent pane may be associated with the window. Alternatively, a transparent sleeve may be disposed between the front and back sides of the display sleeve. It may be configured to hold the advertising information sheet for viewing through the window. The transparent sleeve may have an open end, and may be attached inside the display sleeve to the front side of the display sleeve.

In another aspect, the front and back sides of the display sleeve are attached along two respective side edges, and are not attached along two other respective edges. The display sleeve may be formed of at least one of a poster-board paper and cardboard. The sleeve may include a fold attaching the front and, back sides at one side edge. The front and back sides may be sealed together along another respective side edge. In one aspect, the information may include at least one of warranty information, information about at least one feature of the article of merchandise, a sale price, or service for repair information.

Another aspect is directed to a display. It may include an article of merchandise and the advertisement arrangement attached to the article of merchandise. The article of merchandise may be in any form. Some examples of merchandise articles include luggage pieces, travel bags, bicycles, barbeques, lawn mowers, articles of clothing, or any other article of merchandise. The article of merchandise may be luggage comprising a trolley handle. The display sleeve may be disposed about at least a portion of the trolley handle.

In another aspect, the display may include a second article of luggage and a second advertisement arrangement. The advertising information sheets of both the first and second advertisement arrangements may include information relating to the same type of luggage. The information of the advertising information sheet of the first advertisement arrangement may differ from the information of the advertising information sheet of the second advertisement arrangement.

In another aspect, the front side may include printed matter on the border, and the display sleeve may be configured to attach to the article of merchandise.

In another aspect, the present invention may be directed to a method of advertising using the advertising arrangement. The method may include the steps of displaying an article of merchandise so as to permit the article of merchandise to be viewed by at least one customer, removably attaching an advertisement holder to the article of merchandise. The advertisement holder may include a border and a window having a perimeter defined at least partially by the border. The method may also include providing an advertising information sheet within the advertisement holder. The advertising information sheet may include information pertaining to the article of merchandise. The advertising information sheet may be arranged within the advertisement holder so that the information is visible through the window. It may be configured to allow the advertising information sheet to be exchanged for a different advertising information sheet.

In addition to the structural and procedural arrangements set forth above, the invention could include a number of other arrangements such as those explained hereinafter. It is to be understood that both the foregoing general description and the following detailed description are exemplary only.

### BRIEF DESCRIPTION OF THE DRAWINGS

The accompanying drawings, which are incorporated in and constitute a part of this specification, illustrate embodiments of the invention and together with the description, serve to explain some principles of the invention.

FIG. 1 is a pictorial representation of an embodiment of a display in accordance with the present invention.

FIG. 2 is a pictorial representation of a front side of a display sleeve embodiment for the display of FIG. 1.

FIG. 3 is a pictorial representation of a back side of the display sleeve of FIG. 2.

FIG. 4 is a pictorial representation of a side view of the display sleeve of FIG. 2.

FIG. 5 is a pictorial representation of a side view of the display sleeve of FIG. 2, wherein the side shown in FIG. 5 is opposite the side shown in FIG. 4.

FIG. 6 is a pictorial representation of the display sleeve of FIG. 2 in an open configuration.

FIG. 7 is a pictorial representation of a top view looking into the display sleeve of FIG. 2.

FIG. 8 is a pictorial representation of the display sleeve of FIG. 2 with a transparent sleeve and an advertising sheet.

### DESCRIPTION OF THE EMBODIMENTS

Reference will now be made in detail to exemplary embodiments of the invention, an example of which is illustrated in the accompanying drawings. Wherever possible, the same reference numbers will be used throughout the drawings to refer to the same or like parts.

Some embodiments of the present invention may include an advertisement arrangement for an article of merchandise, service or item of public interest. The advertising arrangement may be attached directly to an article of merchandise for simple identification of the merchandise, and for simple viewing by a potential customer. It may be made to appeal to potential customers tastes by having an elegant appearance. Further, it may be capable of allowing an advertising sheet, with information about the merchandise, to be exchanged for a different advertising sheet. Because only the advertising sheet is exchanged, the advertisement arrangement may be reused to advertise more than one type of product. Therefore, it may maintain its usefulness even after a product line is cancelled or an event ends, reducing display manufacturing costs.

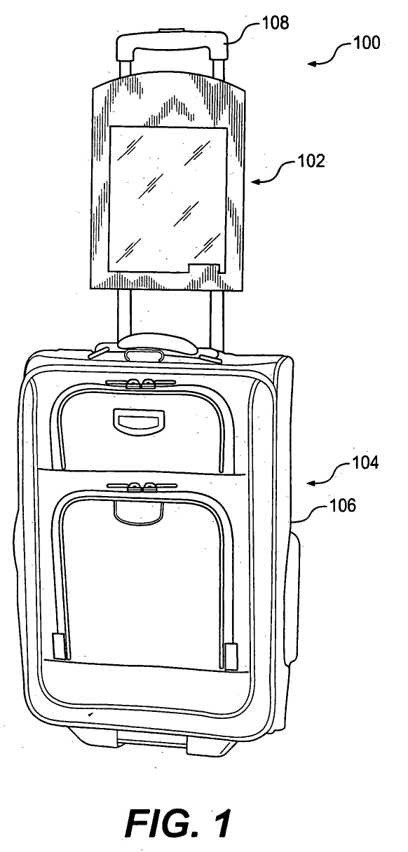

FIG. 1 shows one example of a display 100. It may include an advertisement arrangement 102 removably attached to an article of merchandise 104. In the exemplary display 100 of FIG. 1, the article of merchandise 104 is an article of luggage 106. It should be readily apparent that the article of merchandise 104 could be any article of merchandise, and is not limited to a luggage article. The advertisement arrangement 102 may be used in any advertising or marketing environment.

The article of luggage 106 has a trolley handle 108, to which the advertisement arrangement 102 is directly attached. Rather than having the advertisement arrangement 102 directly attached to the trolley handle 108, the arrangement 102 may be attached to any other part of the article of merchandise 104.

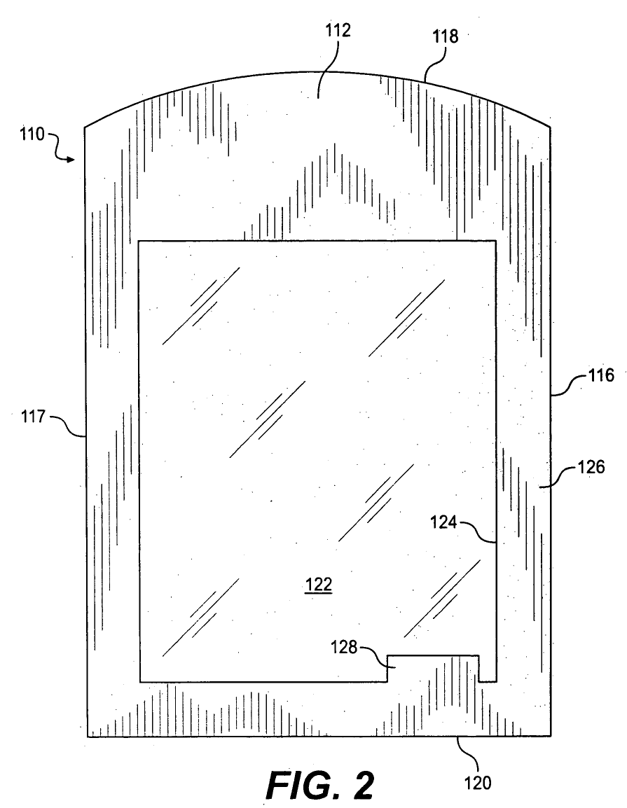

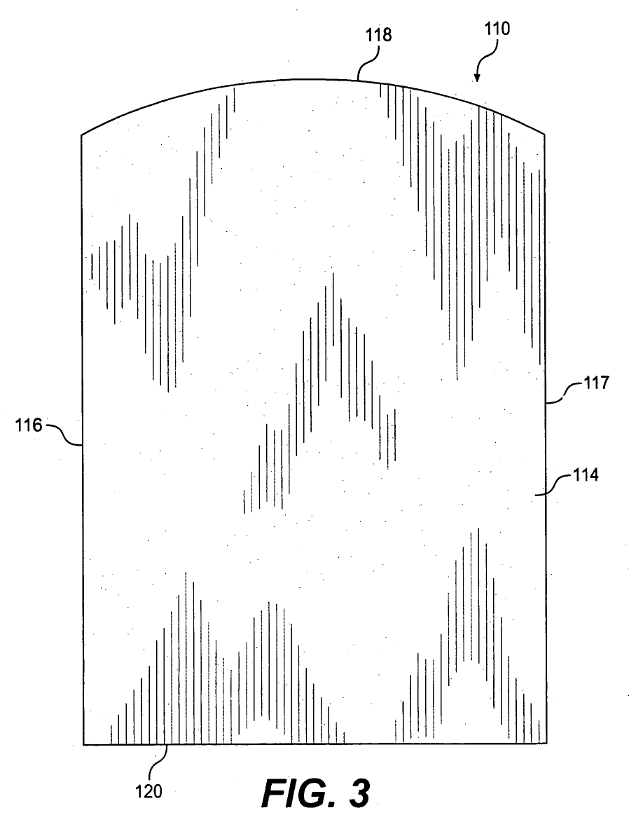

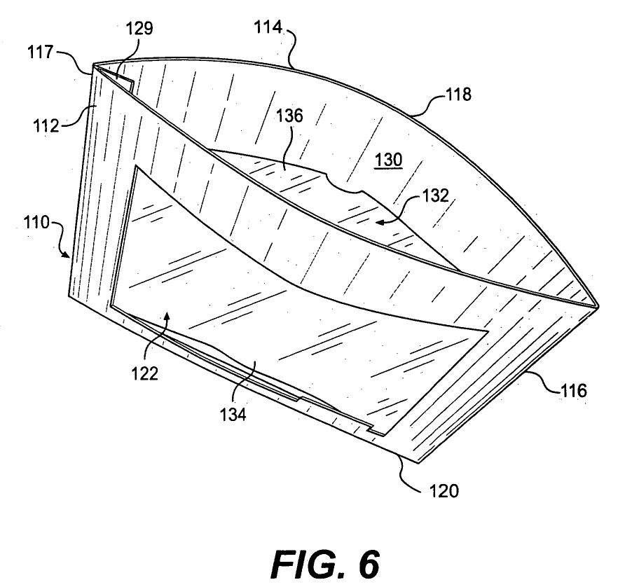

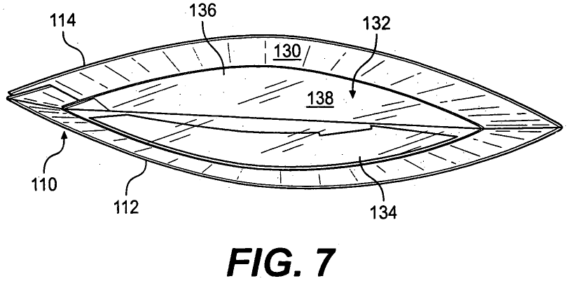

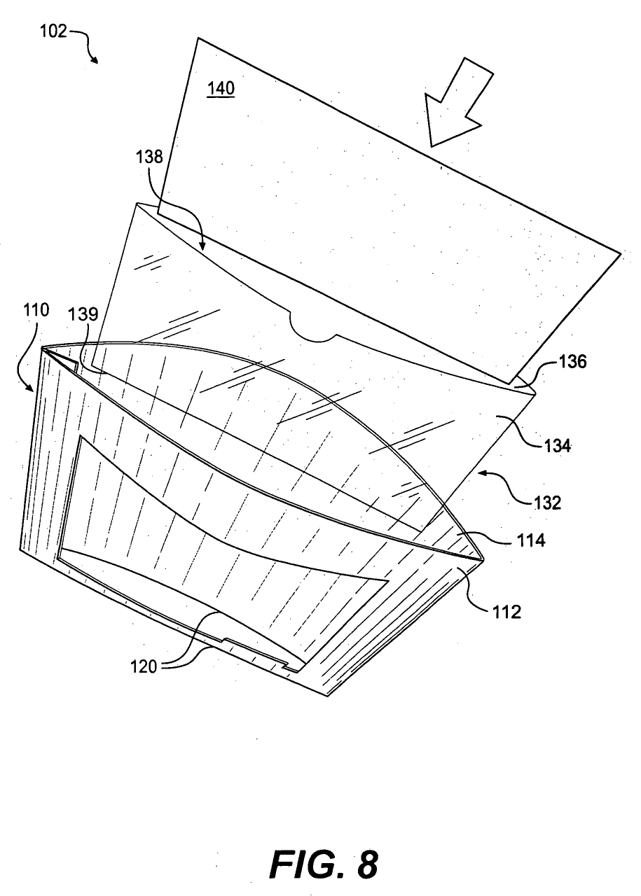

With reference to FIGS. 2-8, the advertisement arrangement 102 may include a display sleeve 110 (FIGS. 2-8), a transparent sleeve 132 (FIGS. 6-8), and an advertising sheet 140 (FIG. 8 One or more sides of the display sleeve 110 may include printed matter intended to advertise a particular type of product or product from a particular manufacturer. The display sleeve 110 may include a front side 112 and a back side 114. The front side 112 and the back side 114 may be formed of any material capable of directly attaching to the article of merchandise 104. In one example, the front side 112 and the back side 114 are formed of a paper material, such as a poster board or cardboard material.

In the example shown, the display sleeve 110 includes two respective side edges 116, 117, a top edge 118, and a bottom edge 120. Also, in the example shown, each of the front and back sides 112, 114 is substantially in the shape of a rectangle having a rounded arc at the top edge 118, extending from one side edge 116 to the other side edge 117.

The front side 112 may include a window 122 defined by a perimeter 124 formed by a border 126. The window 122 may be a through hole or void in the front side 112 of the display sleeve 110, while the border 126 may be formed of display sleeve material around the window 122. In the example shown, the border 126 extends completely around the window 122, but other configurations where the border only extends partially around the window are also possible. The border may include printed matter. As referred to herein, printed matter may be any design, wording, or art, such as, for example, one or more of a manufacture's name, logo, trademark, a solid or non-solid color, shades, pictures, and/or other matter. The printed matter may be generic to more than one article of merchandise so that the display sleeve may be used and reused to advertise more than one article of merchandise.

The window 122 may be any shape, as defined by the perimeter 124. In the example shown, the perimeter 124 and border 126 include a step forming a design tab 128. The design tab 128 may include printed matter. The window and border may be any other shape, as would be apparent to one skilled in the art. In one example, a prospective customer may view advertising information contained within the display sleeve 110 through the window 122.

The back side 116 of the display sleeve may be a continuous surface (i.e., a window or break), and may include printed matter. It may also be formed of a transparent or non-transparent material. In the example shown, the back side 116 is the same size and shape as the front side 112. For some alternative embodiments (now shown), the back side 116 may be formed of less material than the front side 112, and may include a window, or may be formed of one or more strips of material that extend from one side edge 116 to the other side edge 117. Both the front and back sides 112, 114 may include preprinted advertising material, or other designs. In some examples, because the advertising arrangement 102 may be reused with different products, the preprinted information or designs may not be product specific.

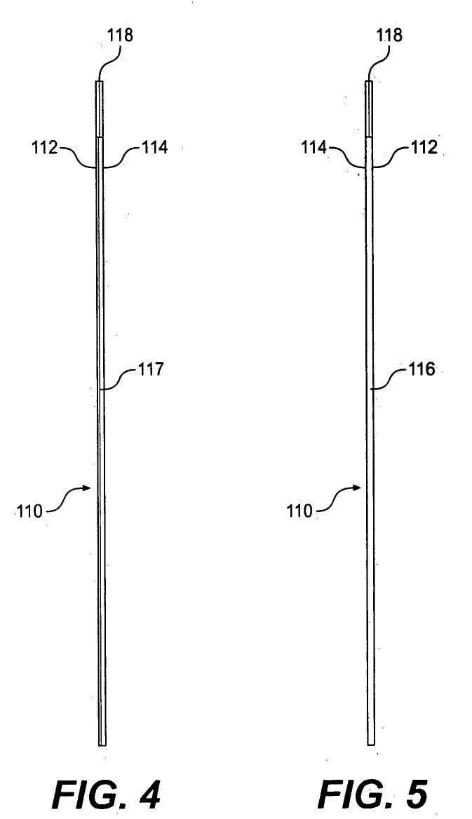

FIGS. 4 and 5 show side views of the side edge 116 and the side edge 117, respectively. In one example, the front side 112 and the back side 114 are formed of a single piece of material, such as poster board or cardboard, that is folded along one edge, such as side edge 116, to form the two sides. Accordingly, as shown in FIGS. 4-6, the top edge 118 may be formed of two layers of material.

The material forming the side edge 117 may include an additional fold of material, forming a connector tab 129 (FIG. 6). In the embodiment shown, the connector tab 129 is formed on the front side 112, and is folded to attach to the back side 114. It should be apparent that a connector tab may be formed on either the front or back sides, and may be adhered to the respective front or back side 112, 114 to connect the front and back sides 112, 114 together. The sides 112 and 114 may be connected together by an adhesive, such as glue or tape, hook-and-loop fastening material, snaps, or otherwise connected to each other at the side edge 117. Although the display sleeve 110 is described as being formed of a single piece of material, the display sleeve 110 could also be formed of two or more pieces of material and may be connected together at both the side edge 116 and the side edge 117. Alternatively, the display sleeve 110 may be wrapped to form the front and back sides 112, 114 of the display sleeve with the ends of the material being connected on the back side, rather than at an edge. The ends may, be connected together by an adhesive, such as glue or tape, hook-and-loop fastening material, snaps, or otherwise connected to each other. The display sleeve may have other arrangements, as would be apparent to one skilled in the art.

FIGS. 6-8 show how the front side 112 and the back side 114 are configured to be flexibly separated from each other so that the display sleeve 110 is placed in an open configuration. In the example shown, the front and back sides 112, 114 are not connected at the top edge 118 and the bottom edge 120. Accordingly, the front and back sides 112, 114 may be flexibly separated from one another between the sides 112 and 114 to form a tube or sleeve. Because of this, the display sleeve 110 includes an interior 130 which may receive a portion of the article of merchandise 104. As shown in FIG. 1, a portion of the article.6of merchandise 104, such as the trolley handle 108, may extend into the interior 130 of the display sleeve 110 such that the sleeve wraps around the merchandise portion. In so doing, the display sleeve 110 is directly attached to the article of merchandise 104. In some alternative embodiments (not shown), the front and back sides 112, 114 may be connected together along three sides of the display sleeve. In these examples, the display sleeve 110 may have a single open end that may receive a portion of the article of merchandise. In other alternative embodiments, one or both of the top and bottom edges 118, 120 may be sealed together, while one or both of the side edges 116, 117 may be separated to provide access the interior 130.

In other exemplary embodiments, the side edge 116 and the side edge 117 have a width that is configured to space the front side 112 from the back side 114. Accordingly, in this embodiment, the interior 130 is formed, by the side edges 116, 117 and the front and back sides 112, 114 without flexing or bending the sides or edges. Accordingly, in this example, the front and back sides 112, 114 need not be flexible pieces, but may be rigid pieces.

Contained within the sleeve interior 130 is a transparent sleeve 132. The transparent sleeve 132 may include a front side 134 and a back side 136, and it may be disposed within the interior 130 in a manner that any material within the transparent sleeve 132 may be viewable through the window 122. In one example, the transparent sleeve 132 is sized larger than the window 122, and may be, for example, sized to receive a sheet of paper having a dimension of approximately 8½ inches×approximately 11 inches. The transparent sleeve 132 may be formed of a single piece of material. In one example, material forming the sleeve may be folded and connected together at its two edges to form a sleeve in a manner similar to the display sleeve 110. In another example, it may be connected at three edges to form a pocket. Accordingly, the transparent sleeve 132 may include an open end 138, and optionally, also include a closed end 139 opposite the open end 138. In still another example, rather than having the transparent sleeve, there is a single layer sheet of transparent material serving as a window pane for the window 122 (e.g., such a sheet may be connected to the interior of the front side 112). In still another example, rather than having a transparent sleeve, an inner sleeve may be formed in the interior 130 of the display sleeve between the front side 112 and a single layer sheet of material serving as a back to the inner sleeve (e.g., such a sheet may be connected to the interior of the front side 112). The single sheet of material could be attached in the sleeve interior 130 to the front side 112 in the form of a sling for supporting an item such as an information sheet, or otherwise attached, such as for example, at three edges of the single sheet of material.

The transparent sleeve 132 may be connected within the interior 130 to the front side 112 of the display sleeve 110. In the example shown, the transparent sleeve 132 is not attached to the back side 114 of the display sleeve 110. Accordingly, the display sleeve 110 may receive a portion of the article of merchandise 104 between the back side 136 of the transparent sleeve 132 and the back side 114 of the display sleeve 110. So doing ensures that any information in the transparent sleeve 132 is viewable through the window 122, and not obstructed by the merchandise in the display sleeve 110.

In some exemplary embodiments, the display sleeve 110 is transparent, and the transparent sleeve 132 is located within the display sleeve 110. In other exemplary embodiments, the transparent sleeve 132 is used without the display sleeve 110, and is configured to wrap around or receive the article of merchandise.

The advertising arrangement 102 may include a replaceable advertising sheet 140 that is sized to be placed within the transparent sleeve 132 of the display sleeve 110, as shown in FIG. 8. In some examples, the advertising sheet 140 may be sized to be larger than the window 122. Accordingly, the border 126 around the window 122 may also serve as a border around the information on the advertising sheet 140.

The advertising sheet 140 may have any advertising information appearing (e.g., printed) for viewing by potential customers. In one embodiment, the advertising information is information that is likely to induce a customer to purchase the article of merchandise. Customers may be induced to purchase an article of merchandise by, for example, a sale price, information about one or more features of the article of merchandise, promotional information (e.g., sale information), warranty information, or service and repair information. Other information that would be likely to induce a customer to purchase the article of merchandise may also be included. In another embodiment the information does not pertain to the article of merchandise.

In one example, the advertising sheet 140 is approximately 8½ inches×11 approximately inches. Accordingly, the transparent sleeve 132 may likewise be sized to receive an advertising sheet 140 that is sized to be approximately 8½ inches×approximately 11 inches. In this example, the window 122 may be approximately 8 inches×approximately 10½ inches so that the edges of the advertising sheet 140 cannot be seen through the window 122. The advertising sheet 140 and window 122 may have any other size as would be apparent to one skilled in the art. The display sleeve 110 and window 122 could have alternative configurations so that information on the advertising sheet 140 may be visible to the customer through the window 122.

To use the advertisement arrangement in a marketing display, the advertising sheet 140, having information regarding the article of merchandise 104 printed thereon, may be placed within the transparent sleeve 132, so that the information is viewable through the window 122.

The advertisement arrangement 102 may directly attach to the article of merchandise 104 as shown in FIG. 1. The display may be located for viewing by customers or potential customers in a retail store, a wholesale store, a trade show, or any other place where an article of merchandise may be displayed. In the example shown, the advertisement arrangement 102 may be removably attached to the article of merchandise 104 by separating the front and back sides 112, 114 of the display sleeve to allow access to the interior 130. A portion of the article of merchandise 104 may be placed within the interior 130, thereby attaching the advertisement arrangement 102 to the article of merchandise 104.

In other examples, the advertisement arrangement 102 may be formed of a transparent sleeve that serves as both the display sleeve 110 and the transparent sleeve 132. In these examples, the display sleeve 110 may or may not include a border. The transparent sleeve in this case may form the front side 112. The back side 114 may be formed by folding or bending the transparent sleeve to make a sleeve structure that can receive a portion of the article of merchandise. Accordingly, one or both of the front and back sides 112, 114 may be formed of transparent material. Alternatively, the back side 114 may be formed of a separate sheet or material attached at side edges of the transparent sleeve. The interior 130 is formed between the front and the back sides 112, 114, as described above. In this example, the advertising sheet 140 may be removably placed within the transparent sleeve.

Because the advertisement arrangement 102 is removably attached to the article of merchandise 104, it may be removed and reused by placing the arrangement 102 on a separate article of merchandise either with the same advertising sheet 140 or a different sheet. Accordingly, when a customer purchases the article of merchandise, the advertisement arrangement 102 may be removed from the article of merchandise 104 and retained for further advertising with the same or a different advertising sheet 140. As used herein, the term “when a customer purchases the article of merchandise” is meant to include the time period immediately preceding and immediately following the actual purchase.

In some examples, several advertisement arrangements 102 may be used in a single marketing display. In those examples, at least one advertisement arrangement may contain an advertising sheet that may be different from at least one other advertising sheet contained in another advertisement arrangement. For example, one advertisement arrangement may include an advertising sheet 140 with information regarding one or more features of the article of merchandise, while a second advertisement arrangement may include an advertising sheet that may include warranty information.

In one example, the marketing display is a set of luggage having multiple pieces. Accordingly, a separate advertisement arrangement may be attached to each of several different pieces of the luggage set. In this exemplary marketing display, at least one of the advertisement arrangements may include an advertisement sheet 140 different from at least one of the advertising sheets of the other advertisement arrangements.

It will be apparent to those skilled in the art that various modifications and variations can be made to the structure and methodology described herein. Thus, it should be understood that the invention is not limited to the subject matter discussed in the specification. Rather, the present invention is intended to cover modifications and variations.

1. An advertisement arrangement for an article of merchandise, comprising:
a display sleeve comprising at least one open end, wherein the display sleeve comprises
a front side comprising a border and a window having a perimeter defined at least partially by the border, and
a back side opposite to the front side,
wherein the front and back sides are flexible so as to permit at least a portion of the article of merchandise to be passed into an interior of the display sleeve via the at least one open end of the display sleeve; and
an advertising information sheet removably disposed within the display sleeve, the advertising information sheet comprising information pertaining to the article of merchandise, the information being visible through the window,
wherein the advertisement arrangement is configured to allow the advertising information sheet to be exchanged for a different advertising information sheet.

2. The advertisement arrangement of claim 1, wherein the information pertaining to the article of merchandise is information likely to induce a customer to purchase the article of merchandise.

3. The advertisement arrangement of claim 1, wherein the advertising information sheet is larger than the window, the advertising information sheet being arranged within the display sleeve so that edges of the information sheet are not visible through the window.

4. The advertisement arrangement of claim 1, further comprising a transparent pane associated with the window.

5. The advertisement arrangement of claim 1, further comprising a transparent sleeve between the front and back sides of the display sleeve, the transparent sleeve being configured to hold the advertising information sheet for viewing through the window.

6. The advertisement arrangement of claim 5, wherein the transparent sleeve is sized to receive a 8½ by 11 inch sheet.

7. The advertisement arrangement of claim 6, wherein the advertising information sheet has dimensions of approximately 8½ inches by approximately 11 inches.

8. The advertisement arrangement of claim 7, wherein the transparent sleeve has an open end, and is attached inside the display sleeve to the front side of the display sleeve.

9. The advertisement arrangement of claim 1, wherein the front and back sides of the display sleeve are attached along two respective side edges, and are not attached along two other respective edges.

10. The advertisement arrangement of claim 1, wherein the display sleeve is formed of at least one of a poster-board paper and cardboard.

11. The advertisement arrangement of claim 10, wherein the sleeve comprises a fold attaching the front and back sides at one side edge, and wherein the front and back sides are sealed together along another respective side edge.

12. The advertisement arrangement of claim 1, wherein the back side is continuous.

13. The advertisement arrangement of claim 1, wherein the information comprises at least one of warranty information, information about at least one feature of the article of merchandise, and a sale price.

14. A display, comprising:
an article of merchandise; and
the advertisement arrangement of claim 1, the advertisement arrangement being attached to the article of merchandise, and wherein the information pertaining to the article of merchandise is information likely to induce a customer to purchase the article of merchandise.

15. The display of claim 14, wherein the article of merchandise is luggage comprising a trolley handle, and wherein the display sleeve is disposed about at least a portion of the trolley handle.

16. The display of claim 15, further comprising:
a second article of luggage comprising a trolley handle,
a second advertisement arrangement, the second advertisement arrangement comprising an advertising information sheet comprising information, the second advertising arrangement being attached to the second article of luggage, and
wherein the advertising information sheets of both the first and second advertisement arrangements comprise information relating to the same type of luggage, and wherein the information of the advertising information sheet of the first advertisement arrangement differs from the information of the advertising information sheet of the second advertisement arrangement.

17. The display of claim 14, further comprising a transparent pane associated with the window.

18. The display of claim 14, wherein the display arrangement comprises a transparent sleeve between the front and back sides of the display sleeve, the transparent sleeve being configured to hold the advertising information sheet for viewing through the window.

19. The display of claim 18, wherein the transparent sleeve is sized to receive a 8½ inch by 11 inch sheet.

20. The display of claim 19, wherein the advertising information sheet has dimensions of approximately 8½ inches by approximately 11 inches.

21. The display of claim 18, wherein the transparent sleeve has an open end, and is attached inside the display sleeve to the front side of the display sleeve.

22. The display of claim 14, wherein the display sleeve is formed of at least one of a poster-board paper and cardboard.

23. The display of claim 22, wherein the sleeve comprises a fold attaching the front and back sides at one side edge, and wherein the front and back sides are sealed together along another respective side edge.

24. The display of claim 14, wherein the back side is continuous.

25. The display of claim 14, wherein the information comprises at least one of warranty information, information about at least one feature of the article of merchandise, and a sale price.

26. The display of claim 14, wherein the front and back sides include a top edge, a bottom edge, and two respective side edges, the front and back sides being attached at the two respective side edges.

27. A method of advertising, comprising;
displaying an article of merchandise so as to permit the article of merchandise to be viewed by at least one customer.
wherein an advertisement holder is removably attached to the article of merchandise, the advertisement holder comprising a border and a window having a perimeter defined at least partially by the border; and
providing an advertising information sheet within the advertisement holder, the advertising information sheet comprising information pertaining to the article of merchandise,
wherein the advertising information sheet is arranged within the advertisement holder so that the information is visible through the window, and wherein the advertisement holder is configured to allow the advertising information sheet to be exchanged for a different advertising information sheet.

28. The method of claim 27, wherein the information on th advertising information sheet comprises information likely to induce a customer to purchase the article of merchandise.

29. The method of claim 27, further comprising:
detaching the advertisement holder from the article of merchandise; and
reattaching the advertisement holder to another of the same type of article of merchandise.

30. The method of claim 27, further comprising:
detaching the advertisement holder when a customer purchases the article of merchandise.

31. The method of claim 27, further comprising:
attaching a second advertisement holder to a second article of merchandise;
providing an advertising information sheet in the second advertisement holder,
wherein the advertising information sheets in both the first and second advertisement holders relate to the same type of merchandise, and wherein the advertising information sheet in the second advertisement holder differs from the advertising information sheet in the first advertisement holder.

32. The method of claim 27, further comprising attaching the advertisement holder to at least a portion of the article of merchandise wherein the attaching comprises placing the advertisement holder around an exterior of said at least a portion of the merchandise.

33. The method of claim 32, wherein the article of merchandise is luggage comprising a trolley handle, and attaching the advertisement holder comprises placing the advertisement holder on at least a portion of the trolley handle.

34. The method of claim 33, wherein placing the advertisement holder on at least a portion of the trolley handle comprises passing said at least a portion of the trolley handle into an interior of the advertisement holder.

35. The method of claim 27, wherein the advertisement holder comprises a transparent sleeve between front and back sides of the advertisement holder, and
wherein providing an advertising information sheet in the advertisement holder comprises providing the advertising information sheet in the transparent sleeve.

36. The method of claim 27, wherein the advertisement holder includes a front side and a back side, the front side comprising the window, and the back side being non-transparent, and wherein providing advertising information sheet comprises placing the advertisement information for viewing through the window.

37. An advertisement arrangement for an article of merchandise, comprising:
a display sleeve comprising at least one open end, the display sleeve comprising a front side comprising a border and a window having a perimeter defined at least partially by the border, and a back side opposite to the front side,
wherein the front side comprises printed matter on the border, and wherein the display sleeve is configured to attach to the article of merchandise; and
an advertising information sheet removably associated with the display sleeve, the advertising information sheet comprising information likely to induce a customer to purchase the article of merchandise, the information on the advertising information sheet being visible through the window.

38. The advertisement arrangement of claim 37, wherein the advertising information sheet is larger than the window, the advertising information sheet being arranged within the display sleeve so that edges of the information sheet are not visible through the window.

39. The advertisement arrangement of claim 37, further comprising a transparent sleeve between the front and back sides of the display sleeve, the transparent sleeve being configured to hold the advertising information sheet for viewing through the window.

40. The advertisement arrangement of claim 39, wherein the transparent sleeve is sized to receive a 8½ by 11 inch sheet.

41. The advertisement arrangement of claim 39, wherein the transparent sleeve has an open end, and is attached inside the display sleeve to the front side of the display sleeve.

42. The advertisement arrangement of claim 37, wherein the display sleeve is formed of at least one of a poster-board paper and cardboard.

43. An advertisement arrangement, comprising:
a display sleeve comprising at least one open end, wherein the display sleeve comprises
a front side comprising a border and a window having a perimeter: defined at least partially by the border, and
a back side opposite to the front side,
wherein the front and back sides are flexible so as to permit at least a portion of the article of merchandise to be passed into an interior of the display sleeve via the at least one open end of the display sleeve;
a transparent pane associated with the window and disposed between the front and back sides of the display sleeve; and
an advertising information sheet removably disposed within the display sleeve, the advertising information sheet comprising information visible through the transparent pane in the window,
wherein the advertisement arrangement is configured to allow the advertising information sheet to be exchanged for a different advertising information sheet.

44. The advertisement arrangement of claim 1, wherein the transparent pane is a portion of a transparent sleeve configured to hold the advertising information sheet for viewing through the window.

45. An advertisement arrangement for an article of merchandise, comprising:
a display sleeve comprising at least one open end, the display sleeve comprising a front side and a back side opposite to the front side,
wherein the display sleeve is configured to receive a portion of the article of merchandise in an interior of the display sleeve; and
an information sheet removably associated with the display sleeve, the information sheet including information visible through the front side.

46. The advertisement arrangement of claim 45, wherein the front side of the display sleeve is transparent.

47. The advertisement arrangement of claim 45, wherein the front side of the display sleeve comprises a border and a window having a perimeter defined at least partially by the border.

48. The advertisement arrangement of claim 45, wherein the display sleeve comprises at least two open ends.

49. The advertisement arrangement of claim 45, wherein the advertising information sheet comprises information pertaining to the article of merchandise and wherein the advertisement arrangement is configured to allow the advertising information sheet to be exchanged for a different advertising information sheet.

50. The advertisement arrangement of claim 49, wherein the information pertaining to the article of merchandise is information likely to induce a customer to purchase the article of merchandise.

51. The advertisement arrangement of claim 45, wherein front side comprises a border defining a window, the advertising information sheet being viewable through the window.

52. The advertisement arrangement of claim 45, further comprising a transparent sleeve between the front and back sides of the display sleeve, the transparent sleeve being configured to hold the advertising information sheet for viewing through the window.

53. The advertisement arrangement of claim 52, wherein the transparent sleeve is sized to receive a 8½ by 11 inch sheet.

54. A display, comprising:
an article of merchandise; and
the advertisement arrangement of claim 45, the advertisement arrangement being attached to the article of merchandise, and the information sheet comprising information likely to induce a customer to purchase the article of merchandise.

55. The display of claim 54, wherein the article of merchandise is luggage comprising a trolley handle, and wherein the display sleeve is disposed about at least a portion of the trolley handle.

56. The display of claim 54 wherein the display arrangement comprises a transparent sleeve between the front and back sides of the display sleeve, the transparent sleeve being configured to hold the information sheet.

57. The display of claim 54, wherein the display sleeve is configured to receive only a portion of the article of merchandise in the interior of the display sleeve.

58. The advertisement arrangement of claim 45, wherein the display sleeve comprises a transparent sleeve, and the transparent sleeve is configured to wrap around the article of merchandise.

59. The advertisement arrangement of claim 45, wherein the front side of the display sleeve is transparent.

60. The advertisement arrangement of claim 45, wherein the display sleeve is formed of a transparent sleeve configured to receive an advertisement sheet.
